(19) United States
(12) Patent Application Publication
(10) Pub. No.: US 2008/0197095 A1
(43) Pub. Date: Aug. 21, 2008

(54) Foldable portable hoist system

(76) Inventor: Michael Spitsbergen, Poway, CA (US)

Correspondence Address: STRASBURGER & PRICE, LLP, 901 MAIN STREET, SUITE 4400, DALLAS, TX, 75202, US

(21) Appl. No.: 12/070,158

(22) Filed: Feb. 15, 2008

Related U.S. Application Data
(60) Provisional application No. 60/901,448, filed on Feb. 15, 2007.

(51) Int. Cl. B66C 23/62; B66C 23/42; B66C 23/04

(52) U.S. Cl. 212/300; 212/239; 212/348

(57) ABSTRACT

A foldable portable hoist system includes a foldable portable hoist assembly and a mounting base. The foldable portable hoist assembly includes a substantially vertical support, an upper support arm, and a diagonal brace assembly. Hinged attachment of slidable collars on either end of the diagonal brace enables the foldable portable hoist assembly to be folded up for ease of transport and storage.

### CROSS REFERENCE TO RELATED APPLICATION

This application claims the benefit of Provisional U.S. Patent Application No. 60/901448 filed Feb. 15, 2007.

### STATEMENT REGARDING FEDERALLY-FUNDED RESEARCH AND DEVELOPMENT

The invention described in this patent application was not the subject of federally sponsored research or development.

### FIELD

This application pertains to a foldable portable hoist system; more particularly, this application pertains to a foldable portable hoist assembly together with the mountings therefor.

### BACKGROUND

Since the issuance of the applicant's U.S. Pat. No. 6,499,610, the portable hoist assembly described therein has received broad acceptance for a variety of different applications in spaces where portable hoist assemblies have not typically been used—to include aboard submarines.

As the utility of the portable hoist assembly described in U.S. Pat. No. 6,499,610 continues to find acceptance for an increasing number of applications, it has been found that a need has arisen for an improved folding hoist assembly and mounting therefor that can be used with a variety of different vehicles or in applications where little room is available to lift and to maneuver a load.

### SUMMARY

The present invention describes a folding hoist assembly and mountings therefore that can be used in a wide variety of situations where little room is available to lift and maneuver a load.

The disclosed foldable portable hoist assembly includes a substantially vertical support, an upper support arm, a diagonal brace assembly, and a windlass/cable assembly. The upper support arm is hingedly attached to the top of the substantially vertical support. Extending therebetween is the diagonal brace assembly. A first sliding collar which is hingedly attached to one end of the diagonal brace is postionable on and is lockable with respect to the substantially vertical support. A second sliding collar or roller mechanism on the other end of the diagonal brace is positionable on and is lockable with respect to the upper support arm. The windlass/cable assembly may be positioned in a variety of different locations on the foldable portable hoist assembly so that the cable extends over at least a portion of and is supported by the upper support arm.

When the foldable portable hoist assembly is not in use it may be folded into a configuration where the substantially vertical support, the upper support arm, and the diagonal brace become substantially parallel to one another. In a preferred embodiment, the lengths of the substantially vertical support, the upper support arm, and the diagonal brace are substantially equal one to another.

Key to the utility of the disclosed folding hoist system is the variety of different mountings with which the folding hoist assembly may be used.

### BRIEF DESCRIPTION OF THE DRAWING FIGURES

A still better understanding of the foldable portable hoist system of the present invention made be had from a review of the drawing figures and the following Description of the Embodiments wherein:

FIG. 1 is a side elevational view of the foldable portable hoist assembly in its extended orientation ready to lift and maneuver a load using a hook;

FIG. 1A is a first alternate extended orientation of the foldable portable hoist assembly shown in FIG. 1;

FIG. 1B is a second alternate extended orientation;

FIG. 1C is a third alternate extended orientation;

FIG. 2 is a side elevational view of the foldable portable hoist assembly shown in FIG. 1 in a partially folded configuration;

FIG. 3 is a side elevational view of the foldable portable hoist assembly shown in FIGS. 1 and 2 in a folded configuration;

FIG. 3A is a side elevational view of the foldable portable hoist assembly shown in FIGS. 1 and 2 in an alternate folded configuration;

FIG. 4 is a side elevational view of a first alternate embodiment of the foldable portable hoist assembly shown in FIG. 1;

FIG. 4A is a cross-sectional view of a first channel shaped upper support arm at line IV-IV used with the hoist assembly shown in FIG. 4;

FIG. 4B is a cross-sectional view of a second channel shaped upper support arm at line IV-IV used with the hoist assembly shown in FIG. 4;

FIG. 4C is a cross-sectional view of a T-shaped upper support arm that may be used with the hoist assembly shown in FIG. 4;

FIG. 4D is a side elevational view of the embodiment shown in FIG. 4 in its folded configuration;

FIG. 5 is a side elevational view of an alternate embodiment of the foldable portable hoist assembly shown in FIG. 1;

FIG. 5A is a side elevational view of the hoist assembly shown in FIG. 5 in its extended configuration;

FIG. 5B is a side elevational view of an alternate embodiment of the hoist assembly shown in FIG. 4;

FIG. 5C is a side elevational view of the hoist assembly shown in FIG. 5B its extended configuration;

FIG. 6 is an exploded view of the foldable portable hoist assembly positioned over a hoist mount;

FIG. 7 is a perspective view of an outside corner mount for the foldable portable hoist assembly shown in FIGS. 1 and 4;

FIG. 8 is a perspective view of an inside corner mount for the foldable portable hoist assembly shown in FIGS. 1 and 4;

FIG. 9 is an exploded perspective view of a surface mount and post base for the foldable portable hoist assembly shown in FIGS. 1 and 4; and

FIG. 10 is a perspective view of a post base with a telescoping adjustable length support leg extending therefrom.

### DESCRIPTION OF THE EMBODIMENTS

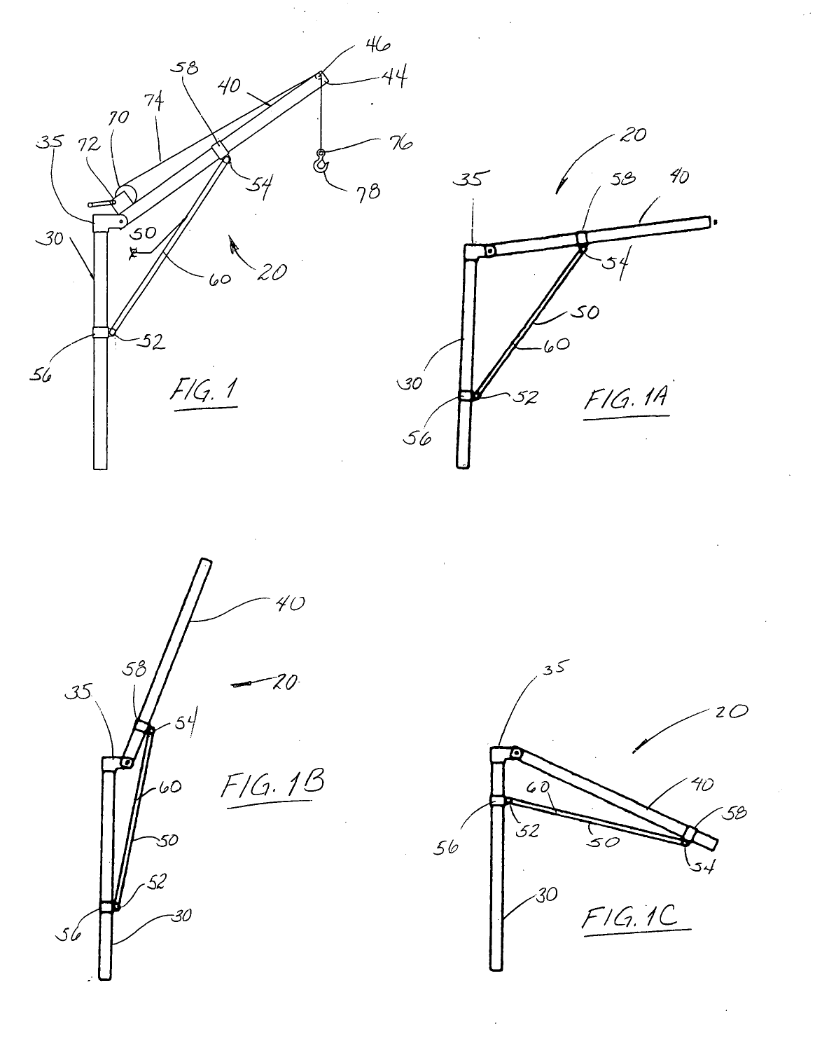

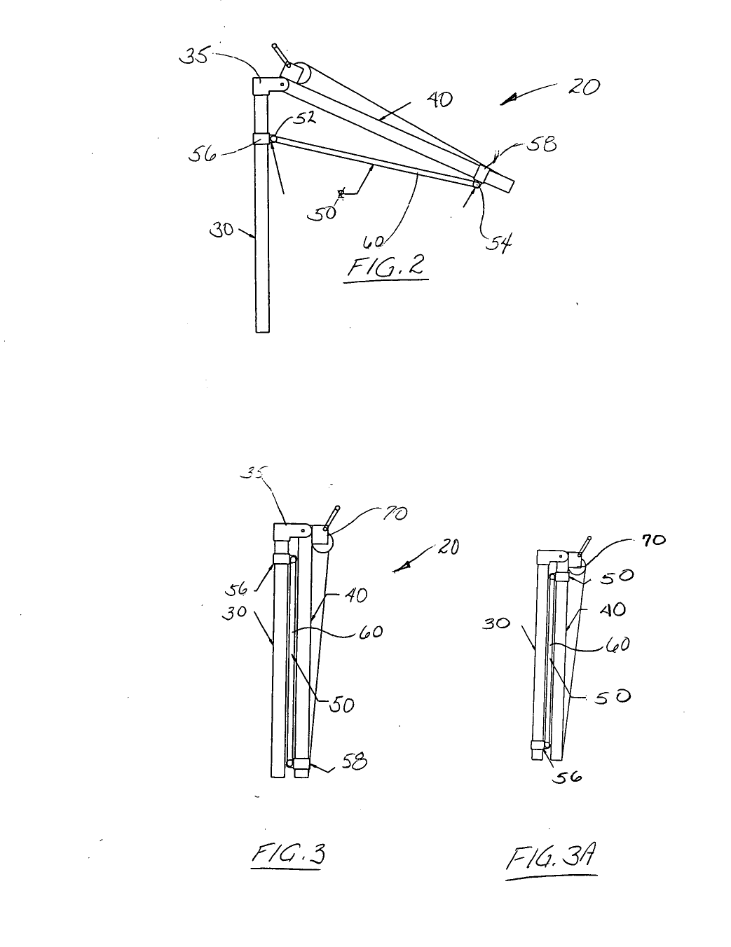

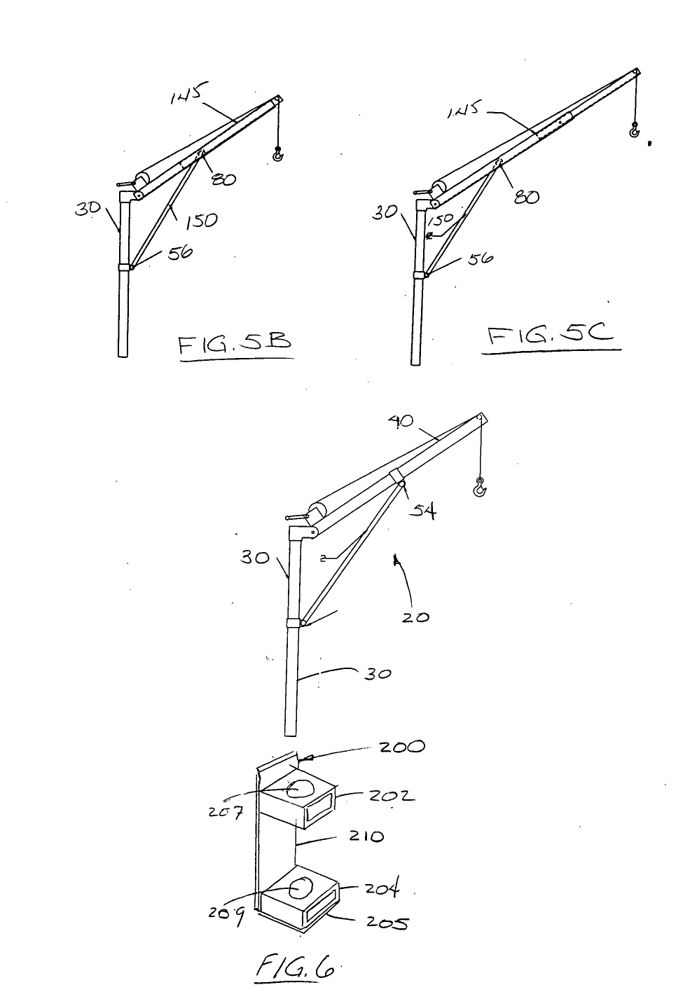

The construction and folding of the foldable portable hoist assembly 20 of the present invention may be best understood by reference to FIGS. 1, 2, and 3. The operation of the foldable portable hoist assembly 20 when combined with a mounting creates a portable hoist system 100 which is best understood by reference to the hoist mounts shown and described with reference to FIGS. 6, 7, 8, 9 and 10.

By reference to FIGS. 1, 2, and 3 the foldable portable hoist assembly 20 of the present invention includes four parts. The first part is the substantially vertical support 30. The second part is the upper support arm 40. The third part is the diagonal brace assembly 50. The fourth part is the windlass/cable assembly 70. Each of these four parts will be described in greater detail in the paragraphs which follow.

The substantially vertical support 30 is a tube having a substantially circular cross section. The size and wall thickness of the substantially vertical support 30 should be selected for bearing both the vertical load and the turnover moments experienced when lifting and maneuvering anticipated loads.

Hingedly attached to the top of the substantially vertical support 30 is an upper support arm 40. The hinged connection 35 between the substantially vertical support 30 and the upper support arm 40 allows the substantially vertical support 30 and upper support arm 40 to become substantially parallel to one another when the portable hoist assembly 20 is moved through its partially folded configuration, shown in FIG. 2, to its fully folded configuration as shown in FIG. 3 or FIG. 3A. The size and wall thickness of the upper support arm 40 should be selected for bearing the weight to be lifted.

As may be seen in FIG. 1A, the foldable portable hoist assembly 20 of the present invention may be set up such that upper support arm 40 forms an approximately 100° angle with respect to the substantially vertical support 30 or an approximately 160° angle as shown in FIG. 1B or an approximately 65° angle as shown in FIG. 1C.

In the preferred embodiment the diagonal brace assembly 50 is a three-piece unit. Hingedly attached to either end 52, 54 of the diagonal brace assembly 50 are sliding collars 56, 58. The first sliding collar 56 is shaped to fit around the substantially vertical support 30. Accordingly the first collar 56 has substantially the same interior shape as the substantially circular cross section of the substantially vertical support 30. The first sliding collar 56 may be locked into a position along the substantially vertical support 30. Such position locking may be accomplished by a pin and hole system, or by a variety of other mechanical engagement systems such as a lever hinged spring pin, clamps or spring detents well known to those of ordinary skill in the art. The hinged attachment 52 of the first sliding collar 56 to the diagonal brace piece 60 enables multiple positioning of the diagonal brace piece 60 with respect to the substantially vertical support 30. The diagonal brace piece 60 may be tubular or solid and may have substantially flat sides or substantially arcuate sides. Such multiple foldable diagonal brace piece 60 positioning is enabled by multiple holes formed in the substantially vertical support 30. It has been found that three hole positions in the substantially vertical support will provide satisfactory results for most applications. A hole position in the central portion of substantially vertical support 30 is shown in FIG. 1. A hole position in the lower portion of the substantially vertical support 30 is shown in FIGS. 1A and 1B. A hole position in the upper portion of the substantially vertical support 30 is shown in FIG. 1C.

The second sliding collar 58 is hingedly attached to the opposite end 54 of the diagonal brace assembly 50. The opening formed within the second sliding collar 58 is the same as the cross-section of the upper support arm 40, be it substantially circular, square, rectangular, or polygonal. As with the engagement of the first sliding collar 56 with the substantially vertical support 30, the locking engagement of the second sliding collar 58 with the upper support arm 40 may be accomplished by use of a variety of positional locking methods such as a pin and hole connection, a lever hinged spring pin, a clamp or a spring loaded detent. Other such locking mechanical connections well known to those of ordinary skill in the art may also be used.

Referring again to FIGS. 1, 1A, 1B and 1C, it may be seen that multiple positions of a locking connection between sliding collar 58 and upper support arm 40 have been enabled. For example, sliding collar 58 is positioned substantially in the center portion of upper support arm 40 in FIGS. 1 and 1A but at the inboard of upper support arm 40 in FIG. 1B and at the outboard end in FIG. 1C, while three positions for mounting collars 56, 58 are shown, those of ordinary skill in the art will understand that multiple holes in both the substantially vertical support 30 and in the upper support arm 40 will provide the user with a variety of extended configurations for the disclosed foldable portable hoist assembly. This variety of configurations enables use of the foldable portable hoist assembly 20 in applications where only a small space is available to lift and maneuver a load.

As may be seen by the sequence of drawing figures beginning with FIG. 3 or FIG. 3A, the foldable portable assembly 20 arrives at the job site with the substantially vertical support 30, the diagonal brace assembly 50, and the upper support arm 40 all positional substantially parallel to one another. Then, as shown in FIG. 2, the foldable portable hoist assembly 20 is unfolded by sliding the first slidable collar 56 along the substantially vertical support 30 and the second slidable collar 58 along the upper support arm 40. This action of moving the first slidable collar 56 along the substantially vertical support 36 and the second slidable collar 58 along the upper support arm 40 positions the diagonal brace assembly 50 between the substantially vertical support 30 and the upper support arm 40 by causing the upper support arm 40 to turn about its hinged connection 35 with the substantially vertical support 30.

As shown in FIG. 3, the first slidable collar 56 has been moved to the top of the substantially vertical support 30 and the second slidable collar 58 has been moved to the outboard end of the upper support arm 40 those of ordinary skill in the art will understand that the disclosed portable hoist assembly may also be folded by moving the first slidable collar 56 to the bottom of the substantially vertical support 30 and the second slidable collar 53 to the inboard end of the upper support arm 40. This configuration is shown in FIG. 3A.

As may be seen in FIGS. 1, 2 and 3 the foldable portable hoist assembly 20 further includes a windlass/cable assembly 70. The windlass/cable assembly 70 is shown mounted on the upper support arm 40. Those of ordinary skill in the art will understand that the windlass/cable assembly 70 may be mounted in multiple locations to include on the substantially vertical support 30. From the mounting location of the windlass 72, the cable 74, typically a wire rope or a synthetic rope extends over a pulley 46, a shiv, or a slidable surface on the outboard end 44 of the upper support arm 40. Alternatively, a webbed strap may be used which passes over a roller on the out board end 44 of the upper support arm 40. On the end 76 of the cable 74 is a hook 78 or clevis assembly for attachment to the load to be lifted or maneuvered. While a hand crank windlass is illustrated, an AC or DC powered electric motor or a hydraulic motor may also be used to provide rotational power to the windlass 72.

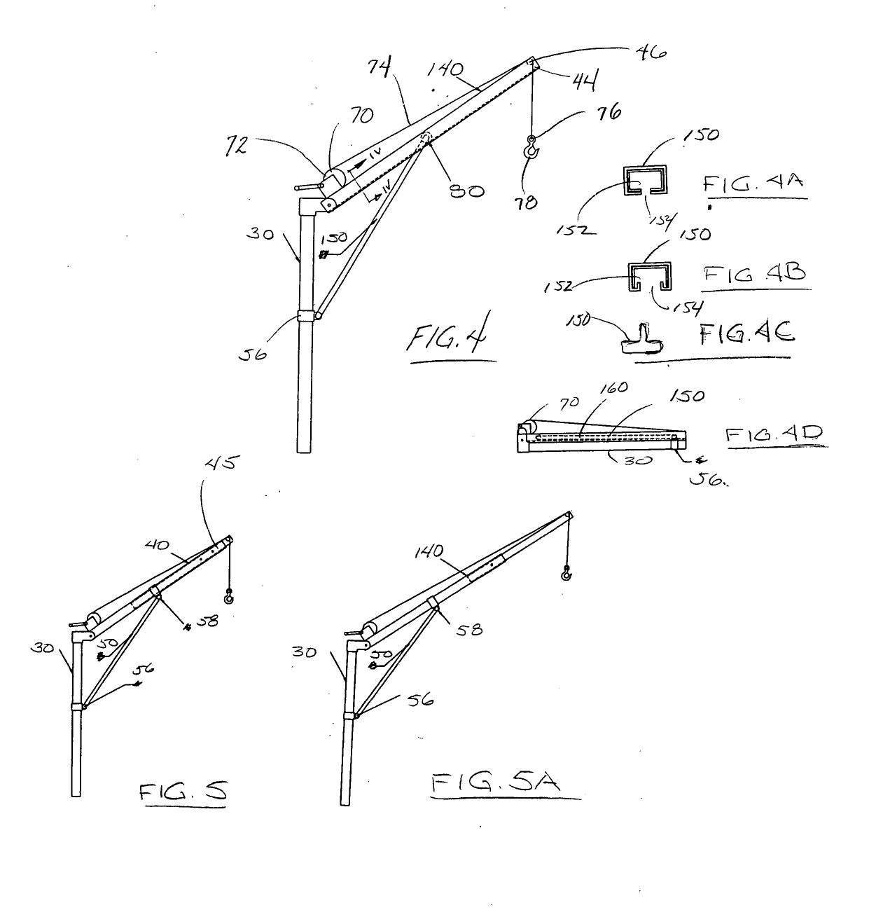

Shown in FIG. 4 is a first alternate embodiment of the portable foldable hoist assembly 20 shown in FIG. 1. Instead of the upper support arm being formed from a pipe, or a tube having substantially flat sides, the upper support arm 150 is formed substantially in the shape of a modified channel as shown in the cross sectional views in FIGS. 4A and 4B. At the outboard end of the diagonal support assembly the sliding collar 58 shown in FIG. 1 has been replaced with a set of rollers 80 which move within the open space 152 within the upper support arm 150. The slot 154 in the channels shown in FIG. 4A and in FIG. 4B provides the access into the open portion 152 of the channel-shaped diagonal support member 150. In another embodiment a T-section as shown in FIG. 4C may be used for the upper support arm 140. Those of ordinary skill in the art will understand that when a T-section is used, the rollers 80 will encircle the T-section and ride on the outside of the upper support arm 140.

Shown in FIG. 4D is the portable foldable hoist assembly shown in FIG. 4 in its folded configuration. Because one end of the diagonal support assembly 150 is within the open portion of the channel, the entire diagonal brace piece 160 will fit within the channel when the hoist is in its folded configuration.

Shown in FIG. 5 is an alternate embodiment of the foldable portable hoist assembly 20 shown in FIG. 1. Located within the upper support arm 40 is an extension piece 45 having telescopic interfitment within the upper support arm 40 and which slides within the opening in a tubular upper support arm 40. The extension piece 45 may be slid out of the upper support arm 40 to give the upper support arm 40 additional length as shown in FIG. 5A. Holding the extension piece 45 in position will be a hole and pin arrangement, a clamp or possibly a spring loaded detent or other similar mechanical connections well known to those of ordinary skill in the art.

Shown in FIG. 5B is an alternate embodiment of the foldable portable hoist assembly shown in FIG. 4. As in FIGS. 5 and 5A, the upper support arm 140 includes an insert which because of its telescopic interfitment within the upper support arm 140 may be slid outwardly to extend the length of the upper support arm 140. As in the embodiment shown in FIG. 5 and FIG. 5A, a pin and hole arrangement, a clamp or a spring detent or other mechanical connections well known to those of ordinary skill in the art may be used to hold the extension piece 145 in position with respect to the upper support arm 140.

Together, the foldable portable hoist assembly and the mounting therefor make up a portable hoist system 100. As will be seen in the paragraphs that follow, the versatility of the disclosed folding portable hoist assembly may be used with a variety of different mountings. While a variety of different mountings are possible, the mountings illustrated in the drawing figures have proven to provide the greatest utility for users of the disclosed embodiments of the foldable portable hoist assembly of the present invention. A single foldable portable hoist assembly is usable in different locations, where in each different location may have a different mounting.

In each mounting for the foldable portable hoist assembly, there is a need to provide mechanical engagement with the substantially vertical support 30 portion of the foldable portable hoist assembly to hold the substantially vertical support 30 in a substantially vertical position when lifting or maneuvering a load. Shown in FIG. 6 is a holster or cup mounting assembly 200. The holster or cup mounting assembly 200 includes two or more ring assemblies 202, 204 and an optional bottom piece 205 affixed in a substantially horizontal orientation with respect to a substantially vertical support member or post 210. The openings within the two or more ring assemblies 202, 204 are sized to accommodate the substantially vertical support 30. The optional bottom piece 205 provides axial load-bearing support for the bottom of the substantially vertical support 30. Thus, because the substantially vertical support 30 has a substantially circular cross section, the two or more ring assemblies 202, 204 will have a large enough substantially circular opening 207, 209 to allow the substantially vertical support 30 to slide therethrough. Improved operation may be achieved if each ring assembly 202, 204 includes a low friction liner 203, 205 to facilitate the passage of the substantially vertical support 30 therethrough.

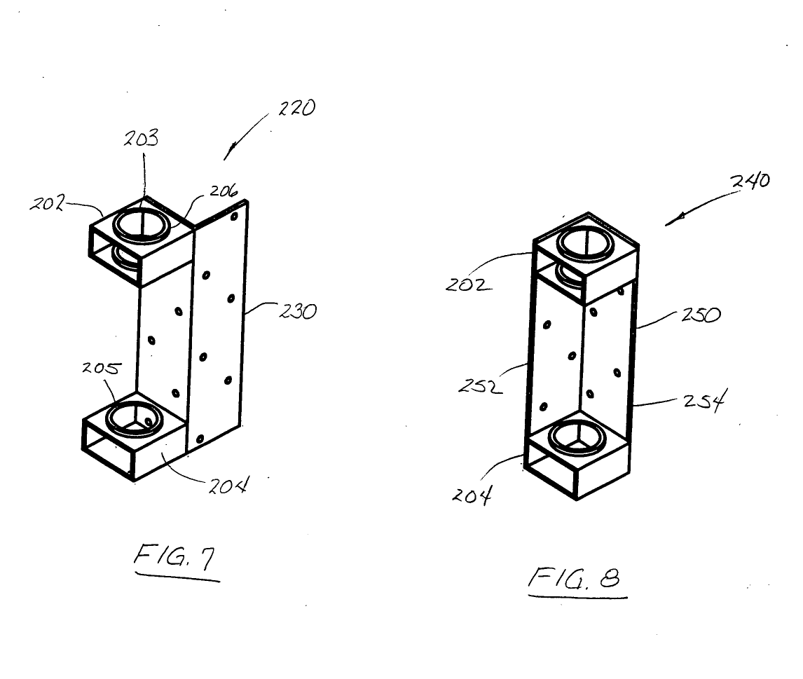

In FIG. 7 an outside corner mount assembly 220 for the foldable portable hoist assembly is shown. The outside corner mount assembly 220 finds particular utility when mounted to the back portion of the cargo bed of a vehicle such as a pick-up truck. Specifically the holster or cup mounting assembly 200 is affixed to or integral with a section of angle iron 230. The section of angle iron 230 is oriented so that its two interior surfaces engage the end of a wall bordering a cargo-carrying space.

In FIG. 8 an inside corner mount 240 is shown. As in FIG. 7, the inside corner mount 240 provides a support for a holster or cup mounting assembly 200. Once again a section of angle iron 250 is used for attachment to or to form a part of the holster or cup mounting assembly 200. However, with embodiment 240 shown in FIG. 8, the outside surfaces 252, 254 of the angle iron 250 are affixed to the inside corner formed by the walls bordering a cargo-carrying space.

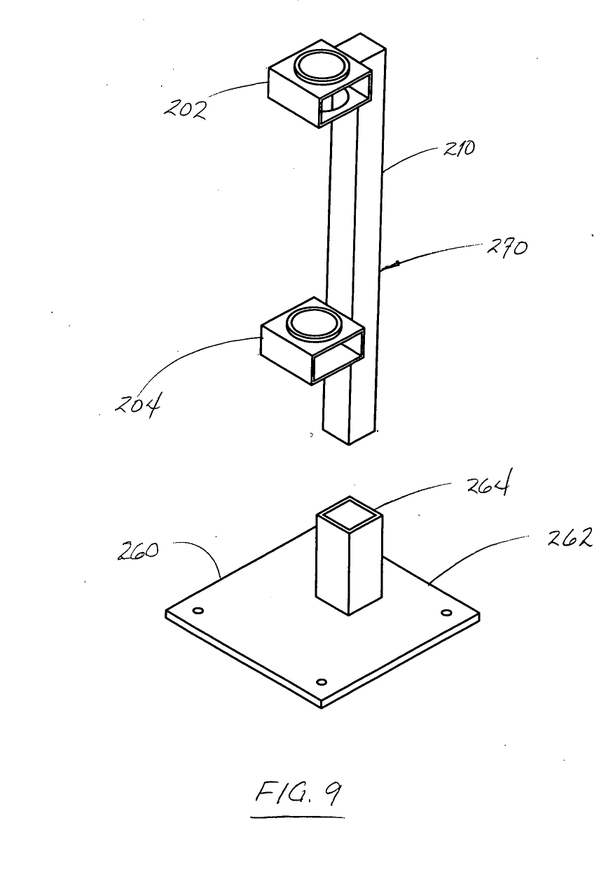

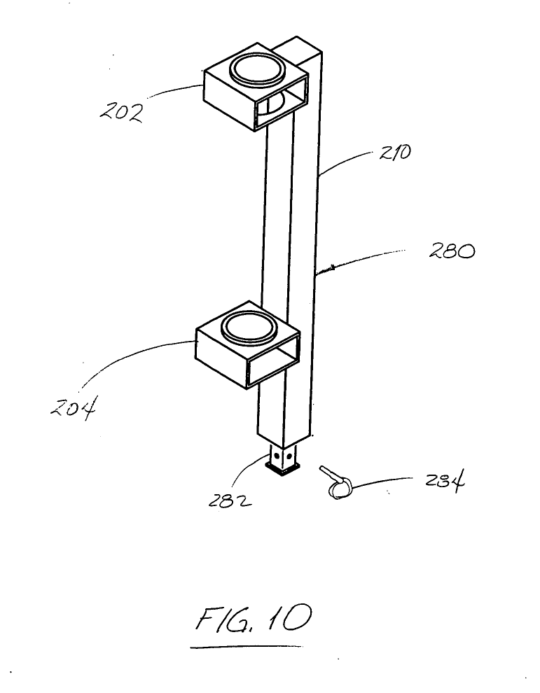

In some applications the cargo-carrying space may open; that is it may not be bordered by walls. In this situation a surface or floor mount arrangement 260 is needed to provide a mounting for the foldable portable hoist assembly which is supported by the floor of the cargo-carrying space. As shown in FIG. 9 a plate 262 is mounted to the floor of a cargo-carrying space. Affixed to the plate is a tubular projection 264. The tubular projection 264 provides a telescopic mounting for the vertical portion 210 of a holster or cup mounting assembly 270.

In some situations it may be necessary to provide additional vertical support for the foldable portable hoist assembly. Such additional support can be provided by utilization of the mounting system 280 shown in FIG. 10. Therein, a telescoping leg 282 extends from the bottom of the vertical portion of the holster or cup mounting assembly 200. The mounting assembly 280 with the telescoping leg 282 may be affixed to another support to keep the mounting assembly 280 with the telescoping leg 282 from turning over when a load is being lifted or maneuvered by the foldable portable hoist assembly 20. A pin and hole connection may be used to position the telescoping leg 282.

The operation of the foldable portable hoist system 100 of the present invention begins by bringing the folded portable hoist assembly to the location where a load is to be maneuvered or positioned. Typically the folded portable hoist assembly is brought to the load location in its folded condition. Because of the light weight of the foldable portable hoist assembly it may be unfolded as described above by reference to drawing FIGS. 3, 2, and 1. The substantially vertical support 30 is then placed through the open spaces in the two substantially horizontally mounted ring assemblies 202, 204 until the bottom of the substantially vertical support 30 makes contact with the optional bottom 205 of the holster or cup base. The foldable portable hoist assembly 20 is now in a position for operation.

Once the foldable portable hoist assembly 20 has been positioned for operation the cable 74 is drawn from the windlass 72 over the upper support arm 40. The hook or clevis on the end of the cable 74 is attached to the load. By turning the reel portion of the windlass 72 when the load is attached to the end of the cable 74, the weight of the load is borne by the disclosed foldable portable hoist assembly. The nature of the holster or cup mounting allows the foldable portable hoist assembly to be rotated within the holster or cup mounting because the substantially vertical support 30 has a circular cross section and the two ring assemblies 202, 204 have circular openings. When the load is the position desired, the reel within the windlass 72 is rotated and the load is set in the desired position.

With the load in the desired position the foldable portable hoist assembly may be removed from its mounting and folded into the configuration shown in FIG. 3 or FIG. 3A. In the preferred embodiment, the substantially equal length of the substantially vertical support 30 the upper support arm 40 and the diagonal brace assembly 50 creates an easy to move, tight package. If desired, the foldable portable hoist assembly may be placed within a carrying bag in its folded condition. Such carrying bags are generally smaller than a bag for a set of golf clubs. By use of a shoulder strap the foldable portable hoist assembly 20 of the present invention is light weight and may be easily carried to jobsites by one person.

While the disclosed foldable portable hoist system of the present invention has been disclosed according to its preferred and alternate embodiments, those of ordinary skill in the art will understand that numerous other embodiments have been enabled. Such other embodiments shall fall within the scope and meaning of the appended claims.

I claim:

1. A foldable portable hoist assembly for supporting a windlass/cable assembly comprising:
a substantially vertical support having an upper end;
an upper support arm hingedly connected at said upper end to said substantially vertical support;
a diagonal brace assembly including:
a first sliding collar hingedly attached to one end of a diagonal brace member and constructed and arranged for lockable engagement with said substantially vertical support;
a second sliding collar hingedly attached to the opposite end of the diagonal brace from the first sliding collar and constructed and arranged for lockable engagement with said upper support arm.

2. The foldable portable hoist assembly as defined in claim 1 wherein said substantially vertical support, said upper support arm and said diagonal brace are substantially the same length.

3. The foldable portable hoist assembly as defined in claim 2 wherein said substantially vertical support, said upper support arm and said diagonal brace member lay substantially parallel to one another when said foldable portable hoist is in its folded configuration.

4. The foldable portable hoist assembly as defined in claim 1 wherein said first sliding collar is attached by a pin and hole arrangement to said substantially vertical support.

5. The foldable portable hoist assembly as defined in claim 1 wherein said second sliding collar is attached by a pin and hole arrangement to said upper support arm.

6. A foldable portable hoist system for supporting a windlass/cable assembly comprising:
a substantially vertical support having an upper end;
an upper support arm hingedly connected at said upper end to said substantially vertical support;
a diagonal brace assembly including:
a first sliding collar hingedly attached to one end of a diagonal brace member and constructed and arranged for lockable engagement with said substantially vertical support;
a second sliding collar hingedly attached to the opposite end of the diagonal brace from the first sliding collar and constructed and arranged for lockable engagement with said upper support arm;
a holster mount including two or more ring assemblies and a bottom piece for supporting said substantially vertical support.

7. The foldable portable hoist system as defined in claim 6 wherein said substantially vertical support, said upper support arm and said diagonal brace are substantially the same length.

8. The foldable portable hoist system as defined in claim 7 wherein said substantially vertical support, said upper support arm and said diagonal brace member lay substantially parallel to one another when said foldable portable hoist is in its folded configuration.

9. The foldable portable hoist system as defined in claim 6 wherein said first sliding collar is attached by a pin and hole arrangement to said substantially vertical support.

10. The foldable portable hoist system as defined in claim 6 wherein said second sliding collar is attached by a pin and hole arrangement to said upper support arm.

11. A foldable portable hoist assembly for supporting a windlass/cable assembly comprising:
a substantially vertical support having an upper end;
an upper support arm hingedly connected at said upper end to said substantially vertical support, said upper support arm having a substantially channel shaped cross-section;
a diagonal brace assembly including:
a first sliding collar hingedly attached to one end of a diagonal brace member and constructed and arranged for lockable engagement with said substantially vertical support;
a set of rotating members hingedly attached to the opposite end of the diagonal brace from the first sliding collar and constructed and arranged for lockable engagement with said upper support arm.

12. The foldable portable hoist assembly as defined in claim 11 wherein said substantially vertical support, said upper support arm and said diagonal brace are substantially the same length.

13. The foldable portable hoist assembly as defined in claim 12 wherein said substantially vertical support, said upper support arm and said diagonal brace member lay substantially parallel to one another when said foldable portable hoist is in its folded configuration.

14. The foldable portable hoist assembly as defined in claim 11 wherein said first sliding collar is attached by a pin and hole arrangement to said substantially vertical support.

15. The foldable portable hoist assembly as defined in claim 1 wherein said set of rotating members are attached by a pin and hole arrangement to said upper support arm.

16. A foldable portable hoist system for supporting a windlass/cable assembly comprising:
a substantially vertical support having an upper end;
an upper support arm hingedly connected at said upper end to said substantially vertical support, said upper support arm having a substantially channel shaped cross-section;
a diagonal brace assembly including:
a first sliding collar hingedly attached to one end of a diagonal brace member and constructed and arranged for lockable engagement with said substantially vertical support;
a set of rotating members hingedly attached to the opposite end of the diagonal brace from the first sliding collar and constructed and arranged for lockable engagement with said upper support arm;
a holster mount including two or more ring assemblies and a bottom for supporting said substantially vertical support.

17. The foldable portable hoist system as defined in claim 16 wherein said substantially vertical support, said upper support arm and said diagonal brace are substantially the same length.

18. The foldable portable hoist system as defined in claim 17 wherein said substantially vertical support, said upper support arm and said diagonal brace member lay substantially parallel to one another when said foldable portable hoist is in its folded configuration.

19. The foldable portable hoist system as defined in claim 16 wherein said first sliding collar is attached by a pin and hole arrangement to said substantially vertical support.

20. The foldable portable hoist system as defined in claim 15 wherein said set of rotating members are attached by a pin and hole arrangement to said upper support arm.

21. The foldable portable hoist assembly as defined in claim 1 further including an extension piece having a telescopic interfitment within said upper support arm.

22. The foldable portable hoist system as defined in claim 6 further including an extension piece having a telescopic interfitment within said upper support arm.

23. The foldable portable hoist assembly as defined in claim 11 further including an extension piece having a telescopic interfitment within said upper support arm.

24. The foldable portable hoist system as defined in claim 16 further including an extension piece having a telescopic interfitment within said upper support arm.
